(19) United States
(12) Patent Application Publication
(10) Pub. No.: US 2015/0192704 A1
(43) Pub. Date: Jul. 9, 2015

(54) METHOD FOR PRODUCING OPTICAL FILM

(71) Applicant: FUJIFILM Corporation, Tokyo (JP)

(72) Inventors: Kenichi YASUDA, Kanagawa (JP); Hiroyuki YUKAWA, Kanagawa (JP); Yuki SAIKI, Kanagawa (JP)

(73) Assignee: FUJIFILM Corporation, Tokyo (JP)

(21) Appl. No.: 14/589,325

(22) Filed: Jan. 5, 2015

(30) Foreign Application Priority Data
Jan. 7, 2014 (JP) 2014-001115

(51) Int. Cl. G02B 1/12; G02F 1/1335; B05D 3/06

(52) U.S. Cl. CPC G02B 1/12; B05D 3/067; G02F 1/1335

(57) ABSTRACT

The method for producing an optical film includes a film-curing step of curing the coating to form a liquid crystal layer by supporting a second surface of the transparent support by a back-up roller while heating, and irradiating the coating with ultraviolet light, wherein, when an reaching temperature of the transparent support in curing of the coating is set to 80° C. or higher, and P [N/m²] represents a surface pressure, T [N] represents a tensile force applied to the transparent support, R [m] represents a radius of the back-up roller, L [m] represents a width of the transparent support, and G [GPa] represents an elastic modulus in a width direction of the transparent support at the reaching temperature of the transparent support in curing of the coating, Expression (1): P=T/RL and Expression (2): P>69/(G−1.5)+400 are satisfied.

### CROSS-REFERENCE TO RELATED APPLICATIONS

The patent application claims priority under 35 U.S.C. §119 to Japanese Patent Application No.2014-001115, filed on Jan. 7, 2014. The above application is hereby expressly incorporated by reference, in its entirety, into the present application.

### BACKGROUND OF THE INVENTION

1. Field of the Invention

The present invention relates to a method for producing an optical film.

2. Description of the Related Art

An optical film is attached to a liquid crystal display in order to improve the viewing angle of a liquid crystal display and to suppress the hue change. As a method for producing the optical film, a method is used which includes preparing a coating liquid having a liquid crystalline compound dissolved in an organic solvent, conveying a continuous transparent support, and applying the coating liquid to the transparent support, and drying and curing the applied coating liquid. The optical film is demanded to have a liquid crystal layer with uniform orientation property. Therefore, a liquid crystal layer is formed by: applying a liquid crystalline compound to a transparent support to which an orientation layer has been applied; drying the coating; and polymerizing and curing the coating with light or heat.

Film-curing by ultraviolet irradiation or the like is an effective method in terms of the productivity and performance of an optical film. Japanese Patent Application Laid-Open No. 2006-267628 and Japanese Patent Application Laid-Open No. 2007-101658 describe a method for producing an optical film in which a coating is cured by irradiation with ultraviolet light under heating.

In the case of production of an optical film, a transparent support is demanded to have flatness during a production process. Therefore, it is necessary to suppress the occurrence of wrinkle on the transparent support during the production process. Japanese Patent Application Laid-Open No. 2011-115725 discloses that a plastic film is air-pressed by air injected from an air nozzle at a pressure which eliminates a wrinkle or more in a position where the wrinkle starts to occur on the plastic film by heating with a heat roller.

### SUMMARY OF THE INVENTION

Meanwhile, as an image display apparatus including a liquid crystal display is demanded to be smaller and thinner, the thickness of an optical film is demanded to be thinner. In order to address such a demand, a transparent support is demanded to have a thickness of less than 60 μm. If the thickness of the transparent support is thinner, however, the following problem is caused: wrinkle occurs on the optical film in a film-curing step of irradiating a coating with ultraviolet light to cure the film.

In order to suppress the occurrence of wrinkle, it is considered to lower a temperature of the coating in the film-curing step and to increase a surface pressure between the transparent support and a back-up roller by air-pressing or the like. If the temperature of the coating is lowered in the film-curing step, however, a problem is that the orientation necessary for the optical film is not achieved, and even if the surface pressure is increased, no sufficient effect with respect to the occurrence of wrinkle is exerted in a transparent support of less than 60 μm.

In view of the above problems, the present invention aims to provide a method for producing an optical film that can satisfy a required orientation and suppress the occurrence of wrinkle.

A method for producing an optical film according to a first aspect of the present invention, includes: conveying a continuous transparent support having an orientation layer on a first surface and having a thickness of less than 60 μm; applying a coating liquid including a crosslinkable liquid crystalline compound to the orientation layer and drying the applied coating liquid to form a coating; and a film-curing step of curing the coating to form a liquid crystal layer by supporting a second surface of the transparent support by a back-up roller while heating, and irradiating the coating with ultraviolet light, wherein, in the film-curing step, when an reaching temperature of the transparent support in curing of the coating is set to 80° C. or higher, and P [N/m²] represents a surface pressure, T [N] represents a tensile force applied to the transparent support, R [m] represents a radius of the back-up roller, L [m] represents a width of the transparent support, and G [GPa] represents an elastic modulus in a width direction of the transparent support at the reaching temperature of the transparent support in curing of the coating, the following expressions (1) and (2) are satisfied:

P=T/RL Expression (1)

P>69/(G−1.5)+400. Expression (2)

Preferably, the transparent support has a thickness of 35 μm or more and 45 μm or less.

Preferably, the coating is irradiated with ultraviolet light in the film-curing step in a total irradiation amount of 10 mJ/cm² or more and 1000 mJ/cm² or less.

Preferably, the elastic modulus is more than 1.5 GPa and less than 10 GPa in the film-curing step.

Preferably, a concentration of an ultraviolet absorber included in the transparent support is 0 PHR or more and 1.2 PHR or less.

Preferably, the reaching temperature of the transparent support is 80° C. or higher and 140° C. or lower in the film-curing step.

Preferably, the surface pressure is more than 400 N/m² and 3000 N/m² or less in the film-curing step.

A method for producing an optical film according to a second aspect of the present invention, includes: conveying a continuous transparent support having an orientation layer on a first surface and having a thickness of less than 60 μm; applying a coating liquid including a crosslinkable liquid crystalline compound to the orientation layer and drying the applied coating liquid to form a coating; and a film-curing step of curing the coating to form a liquid crystal layer by supporting a second surface of the transparent support by a back-up roller while heating, and irradiating the coating with ultraviolet light, wherein, in the film-curing step, in order that an reaching temperature of the transparent support in curing of the coating is 80° C. or higher, and that an elastic modulus G [GPa] in a width direction of the transparent support at the reaching temperature of the transparent support in curing of the coating and a surface pressure P [N/m²] determined in Expression (1) are in such ranges that no wrinkle occurs on the transparent support, the reaching temperature of the transparent support in curing of the coating is determined by an irradiation amount with the ultraviolet light, a concentration of an ultraviolet absorber in the transparent support, and a temperature of the back-up roller, and the surface pressure P [N/m²] is determined by a tensile force T [N] applied to the transparent support, a radius R [m] of the back-up roller and a width L [m] of the transparent support:

P=T/RL Expression (1).

According to the production method of the present invention, an optical film that can satisfy a required orientation and suppress the occurrence of wrinkle can be obtained.

### BRIEF DESCRIPTION OF THE DRAWINGS

FIG. 1 is a schematic configuration diagram illustrating a coating facility;

FIG. 2 is a graph showing a relationship among an elastic modulus, a surface pressure and the occurrence of wrinkle;

FIG. 3 is a graph of temperature dependence of a TD elastic modulus; and

FIG. 4 is a graph showing a relationship between an amount of temperature increase and an amount of an UV agent.

### DETAILED DESCRIPTION OF THE EMBODIMENTS

Hereinafter, a preferable embodiment of the present invention is described with reference to the attached drawings. The present invention is described with reference to the following preferable embodiment. Modifications can be made by many procedures without departing from the scope of the present invention, and other embodiments other than the present embodiment can be utilized. Accordingly, all modifications within the scope of the present invention are encompassed in claims.

Herein, parts represented by the same symbol in the drawings are the same elements having the same function. In addition, when a numeral range is represented using “to” in the present specification, the upper limit and the lower limit represented by “to” also fall within the numeral range.

A method for producing an optical film of a first aspect is a method for producing an optical film, including: a step of feeding a continuous transparent support having an orientation layer on a first surface and having a thickness of less than 60 μm; a step of forming a coating by applying a coating liquid including a crosslinkable liquid crystalline compound to an orientation layer and drying the applied coating liquid; and a film-curing step of curing the coating to form a liquid crystal layer by supporting a second surface of the transparent support by a back-up roller while heating, and irradiating the coating with ultraviolet light, wherein in the film-curing step, when the reaching temperature of the transparent support in curing of the coating is set to the temperature where the coating satisfies the orientation required for the liquid crystal layer, and P [N/m²] represents a surface pressure, T [N] represents the tensile force applied to the transparent support, R [m] represents the radius of the back-up roller, L [m] represents the width of the transparent support, and G [GPa] represents the elastic modulus in the width direction of the transparent support at the reaching temperature of the transparent support in curing of the coating, the following expressions are satisfied:

P=T/RL, Expression (1)

and

P>69/(G−1.5)+400 Expression (2).

A method for producing an optical film of a second aspect is a method for producing an optical film, including: a step of feeding a continuous transparent support having an orientation layer on a first surface and having a thickness of less than 60 μm; a step of forming a coating by applying a coating liquid including a crosslinkable liquid crystalline compound to an orientation layer and drying the applied coating liquid; and a film-curing step of curing the coating to form a liquid crystal layer by supporting a second surface of the transparent support by a back-up roller while heating, and irradiating the coating with ultraviolet light, wherein in the film-curing step, in order that the reaching temperature of the transparent support in curing of the coating is the temperature where the coating satisfies the orientation required for the liquid crystal layer, and that the elastic modulus G [GPa] in the width direction of the transparent support at the reaching temperature of the transparent support in curing of the coating and the surface pressure P [N/m²] determined in Expression (1) are in such ranges that no wrinkle occurs on the transparent support, the reaching temperature of the transparent support in curing of the coating is determined by the irradiation amount of the ultraviolet light, the concentration of an ultraviolet absorber in the transparent support and the temperature of the back-up roller, and the surface pressure P [N/m²] is determined by the tensile force T [N] applied to the transparent support, the radius R [m] of the back-up roller and the width L [m] of the transparent support:

P=T/RL Expression (1).

The present inventors have made intensive studies about suppression of wrinkle occurring on the transparent support having a thickness of less than 60 μm to in the film-curing step of irradiation with ultraviolet light in the method for producing an optical film. The inventors have found that when the transparent support having a thickness of less than 60 μm is used, wrinkle can be suppressed, in the film-curing step, not only by increase the surface pressure between the transparent support and the back-up roller, but also by setting the elastic modulus in the width direction of the transparent support and the surface pressure in a predetermined range. In particular, it has been effective for suppression of wrinkle to increase the elastic modulus in the width direction of the transparent support and/or the surface pressure. When the temperature of a transparent support including a synthetic resin or a thermoplastic resin becomes higher in the film-curing step, the elastic modulus in the width direction of the transparent support becomes lower. Accordingly, it has been effective to suppress the increase in temperature of the transparent support in the film-curing step, in order to inhibit the elastic modulus of the transparent support from being decreased. The present invention has been conceived based on the above findings and makes it possible to provide an optical film that can satisfy a required orientation and to suppress the occurrence of wrinkle.

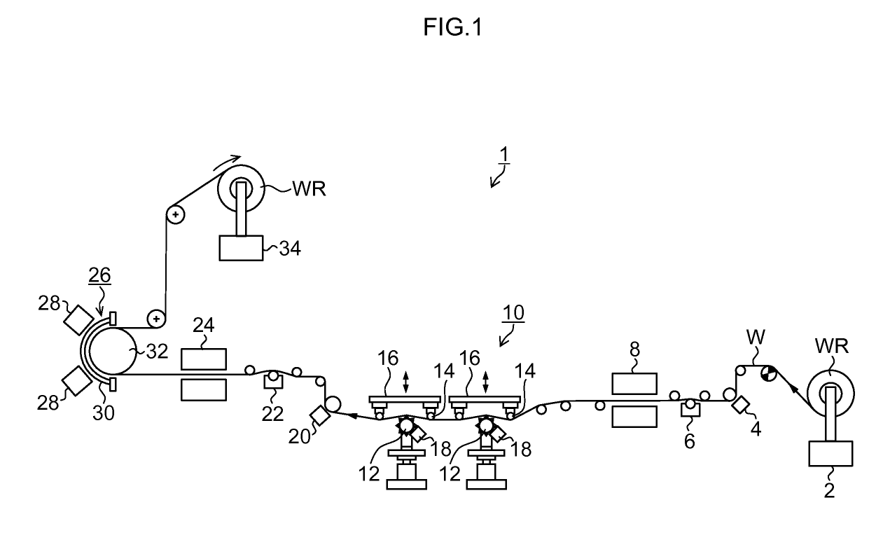

The present embodiment is described with reference to FIG. 1. FIG. 1 illustrates a schematic diagram of a production facility 1 of an optical film. A transparent support roll WR is installed in a feeding machine 2. A transparent support W is conveyed from the feeding machine 2 to each step in the downstream of the feeding machine 2 at a speed of, for example, 10 m/minute or more and 100 m/minute or less. The conveyance speed, however, is not particularly limited. The terms “upstream” and “downstream” are each used with respect to the movement (conveyance) direction of the transparent support W. The position located in the movement (conveyance) direction to a certain standard is defined as “downstream”, and the position located opposite to the movement/conveyance direction is defined as “upstream”.

The transparent support W fed from the feeding machine 2 is conveyed towards a dust eliminator 4 by a driving roller. Dust attached on the transparent support W is removed by the dust eliminator 4. A step of saponification treatment of the transparent support W (not illustrated) can be provided between the feeding machine 2 and the dust eliminator 4.

The transparent support W is conveyed from the dust eliminator 4 towards a coating apparatus 6. The coating apparatus 6 applies a coating liquid including a resin for orientation layer formation (coating liquid for orientation layer formation) to the first surface of the transparent support W. Herein, a coating method applied to the coating apparatus 6 is not particularly limited, and various coating methods such as a spin coating method, a dip coating method, a curtain coating method, an extrusion coating method, a rod coating method or a roll coating method can be adopted. The transparent support W to which the coating liquid has been applied is conveyed from the coating apparatus 6 to a drying apparatus 8. The drying apparatus 8 dries the coating liquid on the transparent support W to form an orientation layer on the first surface of the transparent support W. Herein, a drying system applied to the drying apparatus 8 is not particularly limited, and various drying systems such as a convection drying system by hot air or a radiation drying system by radiant heat such as infrared ray can be adopted.

The transparent support W on which the orientation layer is formed is conveyed towards a rubbing apparatus 10. The rubbing apparatus 10 includes rubbing rollers 12, guide rollers 14 secured on roller stages 16 by springs, and dust eliminators 18 provided to the rubbing rollers 12. A rubbing cloth is attached on the surface of the rubbing roller 12. The rubbing roller 12 is rotated with the rubbing cloth being in contact with the orientation layer, thereby subjecting the orientation layer to a rubbing treatment. While the orientation layer is subjected to a rubbing treatment, dust is eliminated from the surface of the orientation layer by the dust eliminator 18.

The transparent support W having the orientation layer subjected to a rubbing treatment is conveyed towards a dust eliminator 20. The dust eliminator 20 removes dust attached on the transparent support W. The transparent support W having the orientation layer on the first surface thereof is conveyed towards a coating apparatus 22. The coating apparatus 22 applies a coating liquid (liquid crystal layer coating liquid) including a crosslinkable liquid crystalline compound to the orientation layer of the transparent support W. The transparent support W to which the coating liquid has been applied is conveyed from the coating apparatus 22 to a drying apparatus 24. The drying apparatus 24 dries the liquid crystal layer coating liquid on the orientation layer of the transparent support W, thereby forming a coating on the orientation layer. In this step, the coating apparatus 22 allows the orientation layer to be coated with the coating liquid including a crosslinkable liquid crystalline compound, thereby drying the coating liquid by the drying apparatus 24 to form the coating. Herein, the coating method applied to the coating apparatus 22 is not particularly limited, and various coating methods such as a spin coating method, a dip coating method, a curtain coating method, an extrusion coating method, a rod coating method or a roll coating method can be adopted. The drying system applied to the drying apparatus 24 is not particularly limited, and various drying systems such as a convection drying system by hot air or a radiation drying system by radiant heat such as infrared ray can be adopted.

The transparent support W on which the coating is formed is conveyed to an ultraviolet irradiation apparatus 26. The ultraviolet irradiation apparatus 26 is provided with ultraviolet light sources 28 and a casing member 30 which covers a conveyance path of the transparent support W. A back-up roller 32 is disposed at the position opposite to the ultraviolet light sources 28. The second surface (surface opposite to the surface on which the coating is formed) of the transparent support W on which the coating has been formed is supported by the back-up roller 32 while being heated. The coating on the transparent support W supported by the back-up roller 32 is irradiated with ultraviolet light from the ultraviolet light sources 28. The irradiation with ultraviolet light allows the coating to be cured, thereby forming a liquid crystal layer. In this film-curing step, the second surface of the transparent support W is supported by the back-up roller 32 while being heated, and the coating is irradiated with ultraviolet light from the ultraviolet light sources 28, thereby curing the coating to form a liquid crystal layer.

Then, the transparent support W on which the liquid crystal layer is formed is wound up to the transparent support roll WR by a winding machine 34.

The film-curing step of the present embodiment is described in more detail.

The back-up roller 32 in the film-curing step of the present embodiment is provided with a cylindrical main body and a rotation shaft disposed at each of both ends of the main body. The main body of the back-up roller 32 has, for example, a length of 1000 mm or more and 5000 mm or less in the width direction and a radius R of 150 mm or more and 1000 mm or less. The length in the width direction and the radius R of the main body of the back-up roller 32 are not limited. A temperature regulator is mounted to the main body of the back-up roller 32. The temperature regulator can allow the transparent support W to be heated or cooled.

The irradiation with ultraviolet light in the film-curing step of the present embodiment is performed by the ultraviolet irradiation apparatus 26. The ultraviolet irradiation apparatus 26 has the ultraviolet light source 28 which emits ultraviolet light. As the ultraviolet light source 28, for example, a low-pressure mercury lamp, a medium-pressure mercury lamp, a high-pressure mercury lamp, an ultrahigh-pressure mercury lamp, a carbon-arc lamp, a metal halide lamp or a xenon lamp and so on is used. The coating including a crosslinkable liquid crystalline compound formed on the transparent support W is irradiated with ultraviolet light from the ultraviolet irradiation apparatus 26. The irradiation with ultraviolet light can be performed by a single ultraviolet light source 28. Alternatively, the irradiation can be performed by a plurality of the ultraviolet light sources 28 disposed along with the conveyance direction. When the irradiation with ultraviolet light is performed by the plurality of the ultraviolet light sources 28, the irradiation amount by the ultraviolet light sources 28 is preferably gradually made higher from the upstream towards the downstream. In the film-curing step, the total irradiation amount with ultraviolet light is preferably 10 mJ/cm² or more and 1000 mJ/cm² or less. When the total irradiation amount is 10 mJ/cm² or more, the coating including a crosslinkable liquid crystalline compound can be cured. In addition, when the irradiation amount is 1000 mJ/cm² m or less, the flatness of the transparent support W can be prevented from being impaired. When the transparent support W contains an ultraviolet absorber described later, the total irradiation amount with ultraviolet light is preferably determined based on the content of the ultraviolet absorber.

In the film-curing step, the reaching temperature of the transparent support in curing of the coating is required to be set to the temperature where the coating satisfies the orientation required for the liquid crystal layer. The relationship between the orientation of the liquid crystal layer of the optical film produced and the reaching temperature of the transparent support W in the film-curing step is explained based on Table 1. The total irradiation amount with ultraviolet light in the film-curing step is set to 290 mJ/cm².

The orientation of the optical film, namely, the orientation required for the liquid crystal layer can be confirmed by observing the optical film with a polarization microscope. The orientation required for the optical film is rated according to the following criteria.

A: no schlieren occurs at all, and the orientation is uniform.
B: ultrafine schlieren slightly occurs, but is not problematic for a product.
C: ultrafine schlieren slightly occurs and the increase in degree of extinction is observed, but is not problematic for a product. The degree of extinction is 0.01% or less.
D: schlieren occurs or no orientation is observed, and the optical film cannot be used for a product. The degree of extinction is more than 0.01%. Herein, the degree of extinction can be measured using Win6OD (manufactured by Otsuka Electronics Co., Ltd.). The schlieren refers to a phenomenon where, when the refractive index varies depending on a place in a transparent medium, a stripe pattern or haze-like shadow is observed in the place.

In the film-curing step, the reaching temperature of the transparent support W is varied in the range from 60° C. to 160° C., at 20° C. intervals. When the reaching temperature of the transparent support W in the film-curing step is low, the rating of the orientation tends to be low. In addition, when the reaching temperature of the transparent support W is medium, the rating of the orientation tends to be high. When the reaching temperature of the transparent support W is high, the rating of the orientation is slightly lower as compared with the case where the reaching temperature of the transparent support W is medium. The range of the reaching temperature of the transparent support W for achieving a high rating with respect to the orientation varies depending on a material to be used. The qualitative relationship between the temperature of the transparent support W in the film-curing step and the orientation, described above, however, is also the same as that in the case of other material. The reaching temperature of the transparent support W which is required to achieve a demanded orientation, is determined. In general, the reaching temperature of the transparent support W in curing of the coating is preferably 80° C. or higher and 180° C. or lower. By setting the reaching temperature of the transparent support W at 80° C. or higher, it is possible to ensure the orientation required for the optical film. By setting the reaching temperature of the transparent support W at 180° C. or lower, more preferably 140° C. or lower, it is possible to effectively suppress the occurrence of wrinkle.

The reaching temperature of the transparent support W in curing the coating in the present embodiment means the maximum reaching temperature of the transparent support W in ultraviolet irradiation in the film-curing step. The reaching temperature of the transparent support W can be measured by an infrared radiation thermometer.

TABLE 1

| Reaching temperature | Irradiation amount | |
|---|---|---|
| of transparent support | with ultraviolet light | Rating of |
| (° C.) | (mJ/cm²) | orientation |
| 60 | 290 | C |
| 80 | 290 | A |
| 100 | 290 | A |
| 120 | 290 | A |
| 140 | 290 | B |
| 160 | 290 | B |

The present inventors have made intensive studies about the occurrence of wrinkle on the transparent support W satisfying the orientation of the liquid crystal layer in the film-curing step. When the thickness of the transparent support W is less than 60 μm, wrinkle easily occurs on the optical film in the film-curing step. The wrinkle that occurs includes optical wrinkle rated by the unevenness in orientation and physical wrinkle rated by the deformation of the surface. When the thickness of the transparent support W is less than 60 μm, the rigidity of the transparent support W is deteriorated. The deterioration in rigidity of the transparent support W causes the above two wrinkles to occur. The rigidity relates to the elastic modulus of the transparent support W in the width direction. If the elastic modulus of the transparent support W in the width direction is decreased, elastic deformation easily occurs. The width direction herein refers to the direction perpendicular to the conveyance direction of a band-like long transparent support. Before the coating including a crosslinkable liquid crystalline compound is sufficiently cured, optical wrinkle easily occurs under the influence of the elastic deformation of the transparent support W. In addition, if the elastic modulus of the transparent support W in the width direction is decreased, plastic deformation easily occurs. Even after the coating is cured, physical wrinkle easily occurs under the influence of the plastic deformation of the transparent support W. Herein, the elastic deformation and the plastic deformation of the transparent support W occur when the transparent support W is about to extend while avoiding the friction force between the back-up roller 32 and the transparent support.

Then, the present inventors have focused on: the surface pressure between the back-up roller 32 and the transparent support W; the elastic modulus of the transparent support W in the width direction; and the presence or absence of the occurrence of wrinkle in the film-curing step.

In the present embodiment, the wrinkle on the optical film, namely, the wrinkle on the transparent support W refers to wrinkle having a pitch of 10 mm or less, which occurs in the film-curing step. The wrinkle of the transparent support W can be confirmed by cutting the roll of the optical film in the longitudinal direction in a length of 1 m, and subjecting the cut optical film to (1) transmission inspection with respect to optical unevenness and (2) reflection inspection with respect to physical unevenness. The transmission inspection is performed by sandwiching the produced optical film between two polarizing films with which a liquid crystal panel is simulated, and then rotating the optical film to the state where the unevenness is most seen and irradiating the optical film with light from the rear surface. The reflection inspection is performed by horizontally placing the optical film on a flat stand and then irradiating it with light from above, and visually observing the surface shape by the reflection inspection. The occurrence of wrinkle on the optical film is rated according to the following criteria.

A: in the transmission inspection of the film, no unevenness in orientation (optical unevenness) can be observed in a pitch of 10 mm or less, and no wrinkle which is a deformation of the surface is observed by the reflection inspection.
B: in the transmission inspection of the film, no unevenness in orientation can be observed in a pitch of 10 mm or less, and wrinkle which is a deformation of the surface is observed by the reflection inspection, but almost disappears over time.
C: in the transmission inspection of the film, no unevenness in orientation can be observed in a pitch of 10 mm or less, and wrinkle which is a deformation of the surface is observed by the reflection inspection and does not disappear over time and slightly remains.
D: in the transmission inspection of the film, unevenness in orientation can be observed in a pitch of 10 mm or less, and wrinkle which is a deformation of the surface is observed by the reflection inspection and remains even over time without disappearing.

The “wrinkle which is a deformation of the surface” in the rating criteria of wrinkle is based on sensory rating, and rated depending on whether the film is acceptable as a product or not. Accordingly, the rating of the “wrinkle in which the surface is deformed” in the present embodiment is determined according to the criteria different from whether the wrinkle is actually formed on the surface or not.

The elastic modulus of the transparent support W in the width direction in the present embodiment means the difficulty of deformation in the width direction. The elastic modulus of the transparent support W in the width direction can be measured by a viscoelasticity tester.

The surface pressure P [N/m²] applied to the transparent support W on the back-up roller 32 in the present embodiment means the value calculated by P=T/RL with the tensile force T [N] applied to the transparent support W, the radius R [m] of the back-up roller 32, and the width L [m] of the transparent support. The tensile force T applied to the transparent support W is determined by a tension roller, a field roller, and the like placed at the upstream and/or downstream of the back-up roller 32.

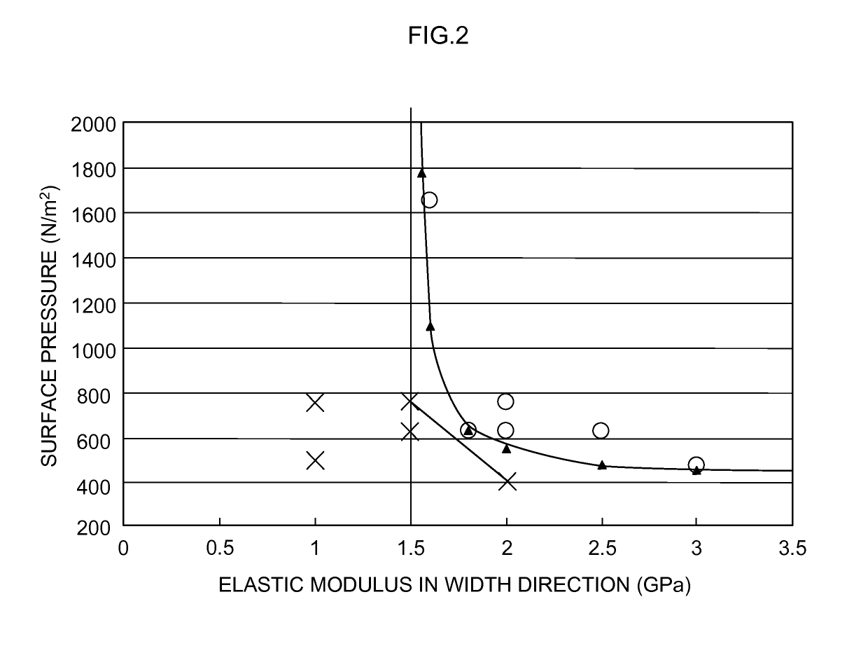

With respect to the elastic modulus at the reaching temperature of the transparent support W, the surface pressure and the presence of the occurrence of wrinkle, the present inventors has plotted a graph, in which the ordinate represents the surface pressure and the abscissa represents the elastic modulus, using a transparent support W having a thickness of 35 μm or more and less than 60 μm, as shown in FIG. 2. In the graph, “Circle mark” represents a point where no wrinkle has occurred and “Cross mark” represents a point where wrinkle has occurred. When the above rating of wrinkle is A to C, the rating here is expressed by “Circle mark”, and when the above rating of wrinkle is D, the rating here is expressed by “Cross mark”. The present inventors have found that there is a region, where the occurrence of wrinkle is suppressed, in the graph. From this graph, a curve whose asymptotic lines are a straight line in parallel with the abscissa passing through a surface pressure P of 400 (N/m²), a straight line in parallel with the ordinate passing through an elastic modulus G of 1.5 (GPa), and a straight line connecting two “Cross marks” has been obtained. As a result, it has been confirmed that the occurrence of wrinkle is suppressed in a region in which P>69/(G−1.5)+400 is satisfied.

In the film-curing step, the elastic modulus of the transparent support W in the width direction is preferably more than 1.5 GPa and less than 10 GPa at the reaching temperature of the transparent support W in curing of the coating. When the elastic modulus of the transparent support W in the width direction is more than 1.5 GPa, wrinkle can be suppressed. An elastic modulus of the transparent support W in the width direction of less than 10 GPa is a value due to a material for use in the transparent support W.

In the film-curing step, the surface pressure P is preferably more than 400 N/m² m² and 3000 N/m² m or less. When the surface pressure P is more than 400 N/m², the occurrence of wrinkle on the transparent support W can be suppressed. A surface pressure P of 3000 N/m² m or less makes it possible to suppress the plastic deformation of the transparent support W.

Then, the method for setting the reaching temperature of the transparent support in curing of the coating at the temperature where the coating satisfies the orientation required for the liquid crystal layer, and setting the elastic modulus G [GPa] of the transparent support W in the width direction and the surface pressure P [N/m²] so that no wrinkle occurs on the transparent support W is described.

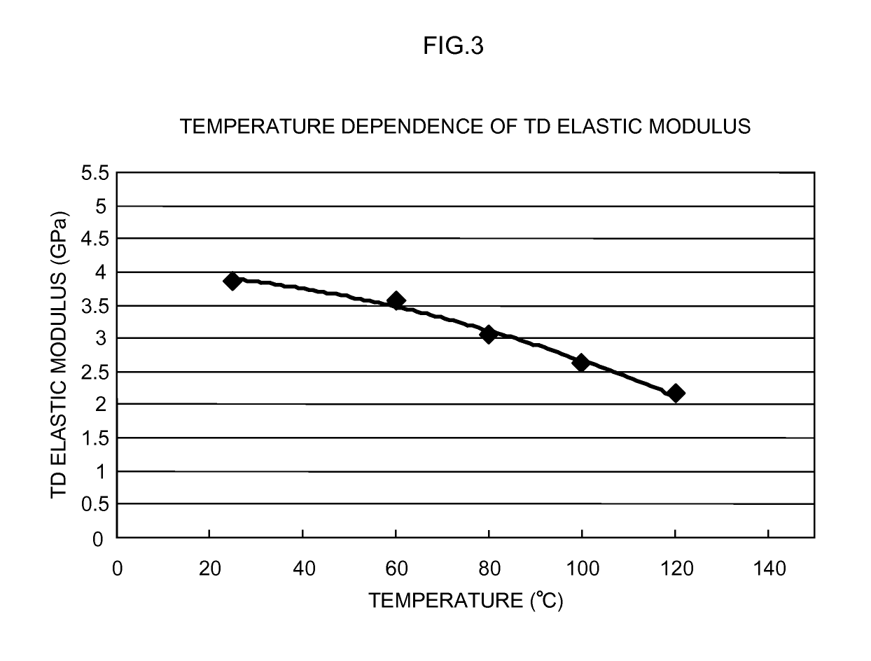

FIG. 3 is a graph of a temperature dependence of the TD ((transverse direction): the width direction of the transparent support W) elastic modulus, in which the ordinate represents the TD elastic modulus and the abscissa represents the temperature. As shown in FIG. 3, as the temperature of the transparent support W is higher in the film-curing step, the elastic modulus of the transparent support W in the width direction is lower. When the elastic modulus is lower, wrinkle more easily occurs. Accordingly, in the film-curing step, it is effective for suppressing the reduction in elastic modulus G of the transparent support W to suppress the increase in temperature of the transparent support W. Hereinafter, the method for suppressing the reduction in elastic modulus G is described.

The temperature of the back-up roller 32 can be adjusted to thereby adjust the reaching temperature of the transparent support W within the temperature range in which the coating satisfies the orientation required for the liquid crystal layer. The temperature of the back-up roller 32 is lowered to thereby suppress the increase in reaching temperature of the transparent support W. As a result, the reduction in elastic modulus G of the transparent support W can be suppressed. The temperature of the back-up roller 32 can be determined by on-line adjustment or off-line adjustment. The on-line adjustment means the determination of the temperature in the film-curing step of producing an optical film. The off-line adjustment means the determination of the temperature in a step other than the film-curing step of producing an optical film.

The amount of ultraviolet irradiation from the ultraviolet light source 28 can be adjusted to thereby adjust the reaching temperature of the transparent support W. The amount of ultraviolet irradiation can be reduced to thereby suppress the increase in reaching temperature of the transparent support W. As a result, the reduction in elastic modulus G of the transparent support W can be suppressed. The amount of ultraviolet irradiation from the ultraviolet light source 28 can be determined by on-line adjustment or off-line adjustment.

The concentration of the ultraviolet absorber included in the transparent support W can be adjusted to thereby adjust the reaching temperature of the transparent support. The concentration of the ultraviolet absorber in the transparent support W can be reduced to thereby suppress the increase in reaching temperature of the transparent support W even in the case of irradiation with ultraviolet light. As a result, the reduction in elastic modulus G of the transparent support W can be suppressed. The concentration of the ultraviolet absorber is determined by off-line adjustment.

The surface pressure P applied to the transparent support W on the back-up roller 32 can be adjusted to thereby suppress the occurrence of wrinkle. The surface pressure P can be increased to thereby increase the adhesion between the transparent support W and the back-up roller 32. As a result, the situation such that the elastic deformation and plastic deformation of the transparent support W hardly occur can be achieved. Therefore, occurrence of wrinkle on the transparent support W can be suppressed. The surface pressure P can be determined by on-line adjustment or off-line adjustment.

The material, the production conditions and the like of the transparent support W can be selected to thereby adjust the elastic modulus of the transparent support W. The elastic modulus of the transparent support W can be increased to thereby suppress the reduction in elastic modulus G of the transparent support W in the film-curing step. The elastic modulus of the transparent support W is determined by off-line adjustment.

Herein, in the film-curing step, the occurrence of wrinkle can be suppressed by decreasing the amount of the transparent support W floating from the back-up roller 32 and increasing the surface pressure P.

As described above, the reaching temperature of the transparent support W in curing of the coating is determined by the irradiation amount with ultraviolet light, the concentration of the ultraviolet absorber in the transparent support W, and the temperature of the back-up roller 32.

In the present embodiment, the optical film means a film at least including the transparent support W, the orientation layer formed on the transparent support, and the liquid crystal layer formed on the orientation layer.

The transparent support W in the present embodiment has a first surface and a second surface opposite to each other, has a distance between the first surface and the second surface, namely, a thickness of less than 60 μm, and has an elongated shape.

The transparent support W preferably has a thickness of 35 μm or more and 45 μm or less. From the viewpoint of easiness of film formation on the transparent support W, the thickness of the transparent support W is preferably 35 μm or more. In addition, from the viewpoint of a requirement for a thinner optical film, the thickness of the transparent support W is preferably 45 μm or less.

The transparent support W has, for example, a width L of 1000 mm or more and 2500 mm or less. In addition, the transparent support has, for example, a length of 1000 m or more. The width and the length, however, are not limited such width and length.

The transparent support W is preferably a polymer film. Examples of the polymer film include cellulose ester, polycarbonate, polysulfone, polyethersulfone, polyacrylate and polymethacrylate. Preferable is cellulose ester, more preferable is acetylcellulose, and most preferable is triacetylcellulose. The transparent support W may include, in addition to the above resin, other composition such as a plasticizer and an ultraviolet absorber.

In the present embodiment, as the ultraviolet absorber, one which hardly absorbs visible light having a wavelength of 400 nm or more is preferably used because such an ultraviolet absorber is excellent in absorbing performance of ultraviolet light having a wavelength of 370 nm or less and being favorable in liquid crystal display property. Specific examples of the ultraviolet absorber include a hindered phenol type compound, a hydroxybenzophenone type compound, a benzotriazole type compound, a salicylate type compound, a benzophenone type compound, a cyanoacrylate type compound and a nickel complex salt type compound. Examples of the hindered phenol type compound include 2,6-di-tert-butyl-p-cresol, pentaerithrityl-tetrakis[3-(3,5-di-tert-butyl-4-hydroxyphenyl)propionate], N, N′-hexamethylenebis(3,5-di-tert-butyl-4-hydroxy-hydrocynnamide), 1,3,5-trimethyl-2,4,6-tris(3,5-di-tert-butyl-4-hydroxybenzyl)benzene and tris-(3,5-di-tert-butyl-4-hydroxybenzyl)-isocyanurate. Examples of the benzotriazole type compound include 2-(2′-hydroxy-5′-methylphenyl)benzotriazole, 2,2-methylenebis(4-(1,1,3,3-tetramethylbutyl)-6-(2H-benzotriazole-2-yl)phenol), (2,4-bis-(n-octylthio)-6-(4-hydroxy-3,5-di-tert-butylanilino)-1,3,5-triazine, triethylene glycol-bis[3-(3-tert-butyl-5-methyl-4-hydroxyphenyl)propionate], N,N′-hexamethylenebis(3,5-di-tert-butyl-4-hydroxy-hydrocynnamide), 1,3,5-trimethyl-2,4,6-tris(3,5-di-tert-butyl-4-hydroxybenzyl)benzene, 2(2′-hydroxy-3′,5′-di-tert-butylphenyl)-5-chlorobenzotriazole, (2(2′-hydroxy-3′,5′-di-tert-amylphenyl)-5-chlorobenzotriazole, 2,6-di-tert-butyl-p-cresol and pentaerithrityl-tetrakis[3-(3,5-di-tert-butyl-4-hydroxyphenyl)propionate].

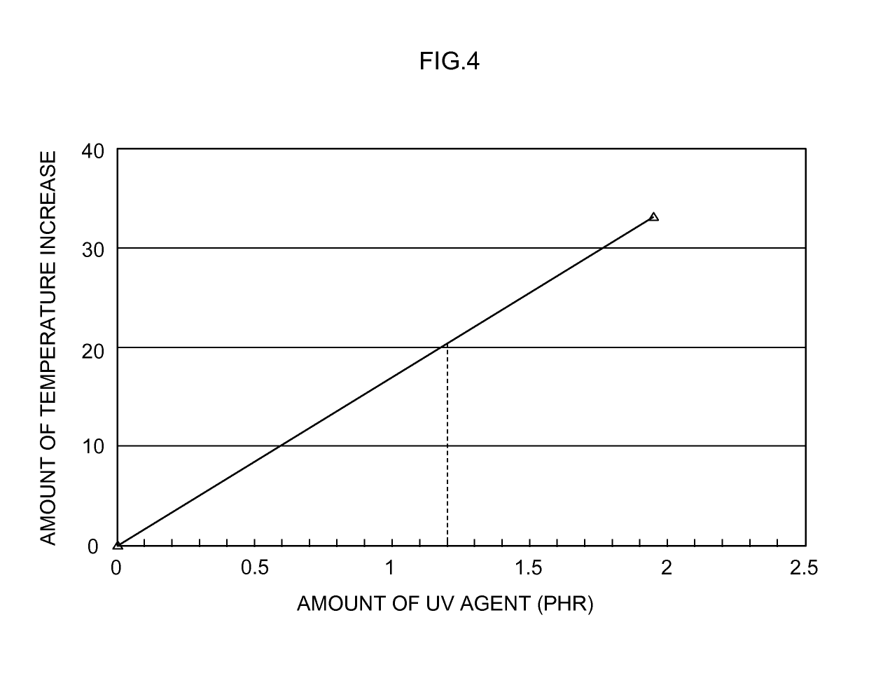

FIG. 4 is a graph showing a relationship between the amount of temperature increase and the amount of the ultraviolet absorber, in which the ordinate represents the amount of temperature increase and the abscissa represents the concentration (the amount of an UV agent) of the ultraviolet absorber. According to this graph, when the concentration of the ultraviolet absorber is higher than 1.2 PHR (PHR: parts by weight per 100 parts by weight resin), the amount of temperature increase of the transparent support W becomes a value exceeding 20° C., as compared with the case where the concentration of the ultraviolet absorber is 0 PHR. When this amount of temperature increase is applied to the graph of the temperature dependence of the TD elastic modulus shown in FIG. 3, the reduction in elastic modulus G can be seen. Accordingly, the concentration of the ultraviolet absorber is preferably 1.2 PHR or less in the entire of the transparent support W, is more preferable as is closer to 0 PHR, and is more preferably 0 PHR. The PHR means part(s) by weight of the ultraviolet absorber based on 100 parts by weight of the resin forming the transparent support W. The ultraviolet absorber in the transparent support W generates heat along with the irradiation with ultraviolet light in the film-curing step. This heat may increase the temperature of the transparent support W. The concentration of the ultraviolet absorber can be within the above-mentioned range to thereby suppress the increase in temperature of the transparent support W, resulting in suppressing the reduction in elastic modulus of the transparent support W. Herein, the concentration of the ultraviolet absorber in the transparent support W can be measured by a spectrophotometer. Herein, the absorption wavelength region and the absorbance of a material may be varied depending on the type of the ultraviolet absorber, and can also be measured by a method in which a calibration curve is created in advance and the ultraviolet light absorbance of a subject is measured.

In the present embodiment, the orientation layer means a layer which orients the liquid crystal layer including a crosslinkable liquid crystalline compound, and has a function of defining the orientation direction of a liquid crystal molecule in the liquid crystal layer. The orientation layer can be provided by means such as a rubbing treatment of an organic compound (preferably polymer), oblique evaporation of an inorganic compound, formation of a layer having a micro group, or accumulation of an organic compound (for example, w-tricosanoic acid, dioctadecyl dimethylammonium chloride or methyl stearate) by the Langmuir-Blodgett method (LB film).

The organic compound includes a methacrylate type copolymer, a styrene type copolymer, polyolefin, polyvinyl alcohol, modified polyvinyl alcohol, poly(N-methylolacrylamide), polyester, polyimide, a vinyl acetate copolymer, carboxymethyl cellulose and polycarbonate. Most preferable are polyvinyl alcohol and modified polyvinyl alcohol.

In the present embodiment, the liquid crystal layer, which is a layer including a crosslinkable liquid crystalline compound, has a function of imparting optical anisotropy. As the crosslinkable liquid crystalline compound, a photocurable liquid crystalline compound is used. The photo-curable liquid crystalline compound is, for example, a rod-like photocurable liquid crystalline compound or a discotic photocurable liquid crystalline compound having a polymerizable group. As the rod-like liquid crystalline compound, azomethines, azoxys, cyanobiphenyls, cyanophenylesters, benzoates, cyclohexanecarboxylic acid phenyl esters, cyanophenylcyclohexanes, cyano-substituted phenylpyrimidines, alkoxy-substituted phenylpyrimidines, phenyldioxanes, tolans, and alkenylcyclohexylbenzonitriles are preferably used. Not only such a low molecular weight liquid crystalline molecule above, but also a high molecular weight liquid crystalline molecule can be used. As the high molecular weight liquid crystal, one in which a rod-like liquid crystal is connected to a high molecular chain in a pendant manner is particularly preferable.

### EXAMPLES

Hereinafter, the present invention is described based on Examples in detail, but the present invention is not limited to these Examples.

### Example 1

Triacetylcellulose having a thickness of 40 μm (Fujitac (trademark), produced by Fujifilm Corporation, elastic modulus at 125° C. in the width direction: 1.8 GPa, ultraviolet absorber: 0 PHR) as the transparent support W was immersed in a 2.0 N aqueous potassium hydroxide solution (25° C.) for 2 minutes, then neutralized by sulfuric acid, washed with pure water and dried. Then, a coating liquid having the following composition was applied to the transparent support W by a wire bar coater. The applied coating liquid was dried by hot air at 60° C. for 60 seconds, and further dried by hot air at 90° C. for 150 seconds to form a film. Then, the film formed was subjected to a rubbing treatment in the direction in parallel with the longitudinal direction of the film, and an orientation layer was formed on the transparent support W.

[Coating Liquid For Orientation Layer Formation]

| | | |
|---|---|---|
| Modified polyvinyl alcohol below | 10 | parts by mass |
| Water | 371 | parts by mass |
| Methanol | 119 | parts by mass |
| Glutaraldehyde | 0.5 | parts by mass |

[Formula 1]
Modified polyvinyl alcohol

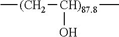

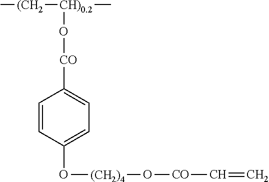

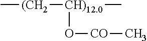

Then, a liquid crystal layer coating liquid shown below was prepared as the coating liquid including a crosslinkable liquid crystalline compound. The liquid crystal layer coating liquid was applied to the orientation layer formed on the transparent support W. Methyl ethyl ketone as a solvent of the coating liquid was volatilized at room temperature, and thereafter the resultant was allowed to stay in a drying zone in a drying step for 2 minutes in the state where the temperature of the coating was 130° C. The coating was irradiated with ultraviolet light in the state that the coating was heated to 110° C. The coating was irradiated with ultraviolet light in a total irradiation amount of 290 mJ/cm² and cured to form a liquid crystal layer. The surface pressure P in the irradiation with ultraviolet light was 750 N/m². Finally, the transparent support W was wound by a winding machine to provide an optical film in Example 1. The reaching temperature of the transparent support W was about 115° C. and the elastic modulus was about 2.3 GPa in the film-curing step.

[Liquid Crystal Layer Coating Liquid]

The following composition was dissolved in 107 parts by mass of methyl
ethyl ketone to prepare a coating liquid. The viscosity of the coating
liquid was adjusted to the desired value by moderating the amount of
methyl ethyl ketone added.

| Discotic liquid crystalline compound below | 41.01 | parts by mass |
|---|---|---|
| Ethylene oxide-modified trimethylolpropane | 4.06 | parts by mass |
| triacrylate (V#360, produced by Osaka Organic | | |
| Chemical Industry Ltd.) | | |
| Cellulose acetate butyrate (CAB551-0.2, | 0.9 | parts by mass |
| produced by Eastman Chemical Company) | | |
| Cellulose acetate butyrate (CAB531-1, | 0.21 | parts by mass |
| produced by Eastman Chemical Company) | | |
| Fluoroaliphatic group-containing polymer | 0.14 | parts by mass |
| (Megafac (trademark) F780 produced by DIC | | |
| Corporation) | | |
| Photopolymerization initiator (Irgacure | 1.35 | parts by mass |
| (trademark) 907, produced by Ciba-Geigy K.K.) | | |
| Sensitizer (Kayacure (trademark) DETX, | 0.45 | parts by mass |

produced by Nippon Kayaku Co., Ltd.)

[Formula 2]
Discotic liquid crystalline compound

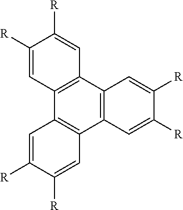

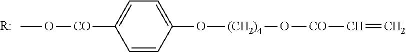

### Example 2

An optical film was produced by the same method as in Example 1 except that triacetylcellulose having a thickness of 45 μm was used as the transparent support W.

### Example 3

An optical film was produced by the same method as in Example 1 except that triacetylcellulose having a thickness of 35 μm was used as the transparent support W.

### Comparative Example 1

An optical film was produced by the same method as in Example 1 except that triacetylcellulose having a thickness of 40 μm (Fujitac (trademark), produced by Fujifilm Corporation, elastic modulus at 125° C. in the width direction: 0.9 GPa, ultraviolet absorber: 0 PHR) was used as the transparent support W. The reaching temperature of the transparent support W was about 115° C. and the elastic modulus was about 1.4 GPa in the film-curing step.

### Comparative Example 2

An optical film was produced by the same method as in Example 1 except that triacetylcellulose having a thickness of 40 μm (Fujitac (trademark), produced by Fujifilm Corporation, elastic modulus at 125° C. in the width direction: 1.5 GPa, amount of ultraviolet absorber: 2.5 PHR) was used as the transparent support W. Due to heat generation by the ultraviolet absorber, the reaching temperature of the transparent support W was about 125° C. and the elastic modulus was about 1.5 GPa in the film-curing step.

### Comparative Example 3

An optical film was produced by the same method as in Example 1 except that the coating was irradiated with ultraviolet light at 145° C. in a total irradiation amount with ultraviolet light of 90 mJ/cm² to cure the orientation layer. Due to heat generation by the ultraviolet absorber, the reaching temperature of the transparent support W was about 150° C. and the elastic modulus was about 0.5 GPa in the film-curing step.

### Comparative Example 4

An optical film was produced by the same method as in Example 1 except that the irradiation with ultraviolet light was performed in a total irradiation amount of 1000 mJ/cm² to cure the orientation layer. Due to the irradiation with ultraviolet light, the reaching temperature of the transparent support W was about 130° C. and the elastic modulus was about 1.3 GPa in the film-curing step.

### Comparative Example 5

An optical film was produced by the same method as in Example 1 except that the coating was irradiated with ultraviolet light at 60° C. to cure the orientation layer.

### Comparative Example 6

An optical film was produced by the same method as in Example 1 except that the orientation layer was cured at a surface pressure P of 400 N/m² in the irradiation with ultraviolet light.

### Overall Rating

The case where both the ratings of wrinkle and orientation included no “D” was rated as “G”, and the case where at least one of the ratings of wrinkle and orientation included “D” was rated as “NG”.

The rating results of Examples 1 to 3 and Comparative Examples 1 to 6 are shown in Table 2. According to Table 2, the films in Examples 1 to 3 were rated as “C” or better with respect to wrinkle and orientation.

In Comparative Example 1, the relationship between the elastic modulus G of the transparent support W and the surface pressure P did not satisfy Expression (2), and the rating of wrinkle was “D”. In Comparative Example 2, the transparent support W included 2.5 PHR of the ultraviolet absorber. The irradiation with ultraviolet light caused the ultraviolet absorber to generate heat, and thus the temperature of the transparent support W reached 125° C. The elastic modulus of the transparent support W at this temperature was 1.5 GPa. Accordingly, in Comparative Example 2, the relationship between the elastic modulus G of the transparent support W and the surface pressure P did not satisfy Expression (2), and the rating of wrinkle was D. In Comparative Example 3, the relationship between the elastic modulus G and the surface pressure P did not satisfy Expression (2), and the rating of wrinkle was D. In Comparative Example 4, the relationship between the elastic modulus G and the surface pressure P did not satisfy Expression (2), and the rating of wrinkle was D. In Comparative Example 5, the temperature of the coating did not reach the temperature satisfying the orientation required for the liquid crystal layer, and thus the rating of orientation was D. In Comparative Example 6, the surface pressure P was 400 N/m², and the rating of wrinkle was D.

TABLE 2

| | Wrinkle | Orientation | Overall rating |
|---|---|---|---|
| Example 1 | B | A | G |
| Example 2 | A | A | G |
| Example 3 | C | A | G |
| Comparative Example 1 | D | A | NG |
| Comparative Example 2 | D | A | NG |
| Comparative Example 3 | D | B | NG |
| Comparative Example 4 | D | A | NG |
| Comparative Example 5 | A | D | NG |
| Comparative Example 6 | D | A | NG |

What is claimed is:

1. A method for producing an optical film, comprising:
conveying a continuous transparent support having an orientation layer on a first surface and having a thickness of less than 60 μm;
applying a coating liquid including a crosslinkable liquid crystalline compound to the orientation layer and drying the applied coating liquid to form a coating; and
a film-curing step of curing the coating to form a liquid crystal layer by supporting a second surface of the transparent support by a back-up roller while heating, and irradiating the coating with ultraviolet light,
wherein, in the film-curing step,
when an reaching temperature of the transparent support in curing of the coating is set to 80° C. or higher, and
P [N/m²] represents a surface pressure, T [N] represents a tensile force applied to the transparent support, R [m] represents a radius of the back-up roller, L [m] represents a width of the transparent support, and G [GPa] represents an elastic modulus in a width direction of the transparent support at the reaching temperature of the transparent support in curing of the coating,
the following expressions (1) and (2) are satisfied:
P=T/RL Expression (1)
P>69/(G−1.5)+400 Expression (2).

2. The method for producing an optical film according to claim 1, wherein the transparent support has a thickness of 35 μm or more and 45 μm or less.

3. The method for producing an optical film according to claim 1, wherein the coating is irradiated with the ultraviolet light in the film-curing step in a total irradiation amount of 10 mJ/cm² or more and 1000 mJ/cm² or less.

4. The method for producing an optical film according to claim 1, wherein the elastic modulus is more than 1.5 GPa and less than 10 GPa in the film-curing step.

5. The method for producing an optical film according to claim 1, wherein a concentration of an ultraviolet absorber included in the transparent support is 0 PHR or more and 1.2 PHR or less.

6. The method for producing an optical film according to claim 1, wherein the reaching temperature of the transparent support is 80° C. or higher and 140° C. or lower in the film-curing step.

7. The method for producing an optical film according to claim 1, wherein the surface pressure is more than 400 N/m² and 3000 N/m² or less in the film-curing step.

8. A method for producing an optical film, comprising:
conveying a continuous transparent support having an orientation layer on a first surface and having a thickness of less than 60 μm to;
applying a coating liquid including a crosslinkable liquid crystalline compound to the orientation layer and drying the applied coating liquid to form a coating; and
a film-curing step of curing the coating to form a liquid crystal layer by supporting a second surface of the transparent support by a back-up roller while heating, and irradiating the coating with ultraviolet light,
wherein, in the film-curing step,
in order that an reaching temperature of the transparent support in curing of the coating is 80° C. or higher, and
that an elastic modulus G [GPa] in a width direction of the transparent support at the reaching temperature of the transparent support in curing of the coating and a surface pressure P [N/m²] determined in Expression (1) are in such ranges that no wrinkle occurs on the transparent support,
the reaching temperature of the transparent support in curing of the coating is determined by an irradiation amount with the ultraviolet light, a concentration of an ultraviolet absorber in the transparent support, and a temperature of the back-up roller, and
the surface pressure P [N/m²] is determined by a tensile force T [N] applied to the transparent support, a radius R [m] of the back-up roller and a width L [m] of the transparent support:
P=T/RL Expression (1).
